(19) United States
(12) Patent Application Publication
(10) Pub. No.: US 2008/0291894 A1
(43) Pub. Date: Nov. 27, 2008

(54) METHODS AND APPARATUS TO COMMUNICATE USING A MULTI-FIDELITY AUDIO GATEWAY

(76) Inventors: Hisao Chang, Cedar Park, TX (US); Mark Hubscher, San Antonio, TX (US); Carlton Ligar Brown, San Antonio, TX (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/751,445

(22) Filed: May 21, 2007

(51) Int. Cl. H04L 12/66

(52) U.S. Cl. 370/352

(57) ABSTRACT

Methods and apparatus to communicate using a multi-fidelity audio gateway are described. One example method receives information associated with at least one communication service via a multi-fidelity audio gateway and selects at least one communication path for use by the gateway device based on the communication service.

### FIELD OF THE DISCLOSURE

This disclosure relates generally to communication gateways and, more particularly, to methods and apparatus to communicate via Internet protocol network services using a multi-fidelity audio gateway.

### BACKGROUND

Consumers often have residential or commercial Internet protocol (IP) based broadband access to the Internet via multiple network communication services (e.g., high-speed digital subscriber line (DSL), cable, satellite, fiber, wireless networks such as WiMax, 802.11(b) or (g), etc.). With broadband Internet access, a person may communicate via a plurality of communication services (e.g., electronic mail, instant messaging, etc.) via a presentation device (e.g., a set top box, a game console, a computer, or a computer-based media center). Additionally, broadband Internet access enables persons to consume high-fidelity multimedia content from the Internet. However, the fidelity of the multimedia content ultimately presented to a person is based on the degree to which a system accurately reproduces the essential characteristics of an original signal conveying the multimedia content.

In one known example, a person may consume multimedia content via high-fidelity presentation devices such as a high definition television (HDTV) coupled directly or indirectly to the Internet. For example, a person may purchase and download the content from known sources of multimedia content (e.g., Apple iTunes®, etc.) and then use the presentation device to consume the content. In another known example, users may consume audio content from the Internet via high-fidelity audio devices.

Broadband Internet access also enables a person to communicate via two-way (full duplex) voice communication via the Internet. One known example of a two-way communication is Voice over Internet Protocol (VoIP), which encodes a person's speech into narrow-band data packets (i.e., 64 kilobit data packets). Due to the narrow-band VoIP communications, there is little audio fidelity improvement in two-way voice communications as compared to existing two-way voice calls using a public switched telephone network (PSTN). Despite improvements in bandwidth to persons, even newer VoIP communications based on IP Multimedia Systems architecture route narrow-band VoIP data packets.

### BRIEF DESCRIPTION OF THE DRAWINGS

FIG. 1 is an illustration of an example system for communicating via a multi-fidelity audio gateway.

FIG. 2 is a schematic illustration of the multi-fidelity audio gateway of FIG. 1.

FIG. 3 is a schematic illustration of an example remote device of FIG. 1.

FIG. 4 is a flowchart representative of an example process that may be executed when a service module is inserted into a media system.

FIG. 5 is a flowchart representative of an example process that may be executed to implement the multi-fidelity gateway of FIG. 1.

FIG. 6 is a flowchart representative of another example process that may be executed to implement the multi-fidelity gateway of FIG. 1.

FIG. 7 is a schematic illustration of an example processor platform that may execute the example processes of FIGS. 4, 5, and 6 to implement the media system of FIG. 1.

### DETAILED DESCRIPTION

The audio fidelity of Internet-based voice communications has not improved significantly, especially when considering the improvement in bandwidth available to persons via broadband Internet access. In the following examples, methods and apparatus to communicate via a multi-fidelity audio gateway are described. Although the following examples focus on an example of a residential media system for personal use, the disclosure extends to all environments and applications in which high fidelity communications are useful. For example, the examples described herein may be more generally applied to media systems for business use, educational use, etc.

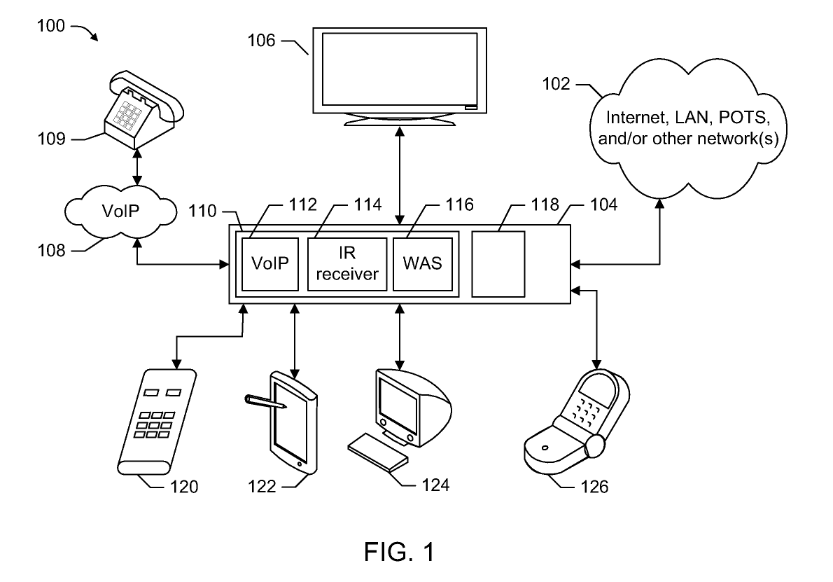

FIG. 1 depicts an example media system 100 that is coupled to a network 102 such as the Internet and/or a local area network (LAN). The media system 100 is coupled to the network 102 via a communications router 104, which may be any type of device that is capable of sending, receiving, and/or routing communication services (e.g., public switched telephone network, Internet protocol packets, etc.). In the example of FIG. 1, the communications router 104 may be a media center or an intelligent media center that connects a plurality of devices to form the media system 100. For example, the communications router 104 may be adapted to send video programs to a display device 106 such as an HDTV. Additionally, any number of devices that send and/or receive communications services via the network 102 may be coupled to the communications router 104, such as a VoIP network 108 coupled to a VoIP phone 109.

The communications router 104 may also receive service modules while the communications router 104 is operating (i.e., the service modules are hot-pluggable and can be installed or removed while the router is operating). The service modules are hardware, software, and/or firmware modules that may include at least network service to the communications router 104. For example, one example service module may be a multi-fidelity audio gateway (audio gateway) 110 that includes a voice over Internet Protocol (VoIP) client 112 to enable communication between people via the network 102. Service modules provide the communications router 104 functionality to perform network-related services and functions that persons may desire. For example, service modules may include, but are not limited to, an Internet protocol television (IPTV) client to receive video programs via the network 102, a PSTN client to send and receive PSTN phone calls, a video conferencing client, etc.

The service modules associated with the media system 100 may also include additional devices inside the service module to provide additional functions to the service module and/or communications router 104. For example, the audio gateway 110 of FIG. 1 includes an infrared (IR) receiver 114 to receive commands from a remote control and a wireless audio system (WAS) device 116 to send and receive high-bandwidth data. The WAS device 116 is a wireless communication link implemented using known wireless techniques (e.g., a radio frequency communication link, wireless universal serial bus, Bluetooth, etc.). Additional devices that may be included with a service module include, but are not limited to, a speech synthesis device to convert text into speech, a speech recognition device to convert speech into text, and a directory device to store contact information for people.

Additionally, the service modules associated with the communications router 104 may interoperate with each other. For example, the audio gateway 110 may send and/or receive communications to a second service module 118, which may be any type of communication service of interest to a person such as, for example, a Bluetooth module, an IPTV module, a PSTN module, a speech recognition module, a text-to-speech module, an address book module, etc. For example, if the audio gateway 110 receives a PSTN phone call, the audio gateway 110 may configure a Bluetooth service module to couple a person's mobile phone to the audio gateway 110 so that the person may answer the PSTN phone call via the mobile phone instead of a PSTN phone.

Consumer devices may also be coupled to the communications router 104 via service modules such as the audio gateway 110. As illustrated in the example of FIG. 1, a remote control 120, a personal digital assistant (PDA) 122, a computer 124, and/or a mobile phone 126 may be coupled to communications router 104. The consumer devices coupled to the communications router 104 may access communication services associated with the media system 100. In one example, the remote control 120 is used to send and/or receive communication services via the audio gateway 110.

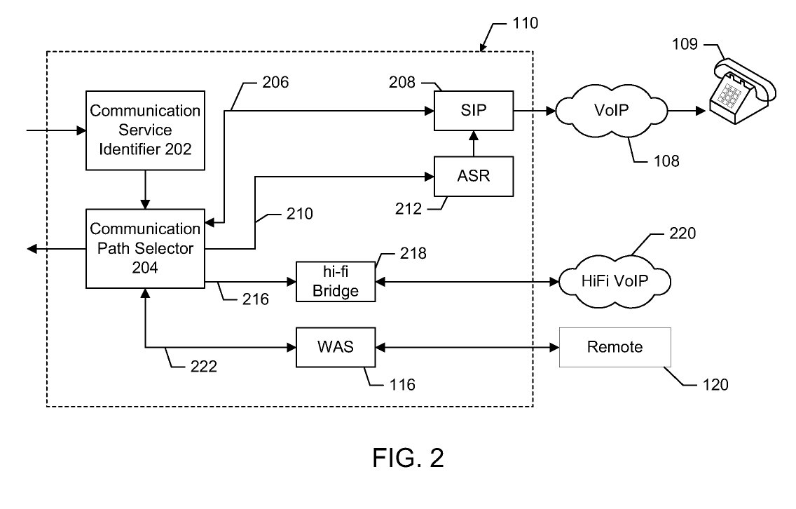

FIG. 2 is a more detailed block diagram of the audio gateway 110. In the example of FIG. 2, the audio gateway 110 receives a communication signal via a communication service identifier 202 to detect or identify the communication service. For example, the communication service identifier 202 detects if the communication signal is a VoIP phone call or speech command from a person. Additionally, the communication service identifier 202 may also detect the fidelity of the communication signal (e.g., the sampling rate of the communication signal, the number of bits associated with the communication signal, and/or the compression algorithm associated with the communication signal). Once the communication service is identified, the audio gateway 110 selects a communication path for the communication signal via a communication path selector 204. As illustrated in the example of FIG. 2, the audio gateway 110 may be associated with at least one communication path.

In the example of FIG. 2, the audio gateway 110 may select the communication path to be used by the audio gateway 110 based on the fidelity of the communication source (e.g., the fidelity of a caller's communication signal). In addition, the audio gateway 110 may select the communication path based on the call recipient's network credentials and audio fidelity. For example, if a call recipient is communicating using a low fidelity VoIP phone (e.g., 64 kilobit data packets), the audio gateway 110 may select a low fidelity VoIP path 206 to the Session Initialization Protocol (SIP) client 208 for low fidelity VoIP communications. A person having ordinary skill in the art will readily recognize that an SIP client creates, modifies, and terminates VoIP calls. The audio gateway 110 may also receive voice commands from a person as a communication source. In the example of FIG. 2, the audio gateway 110 selects a high fidelity path 210 (e.g., 256 kilobit data packets) to an automatic speech recognition device 212 to digitize a person's voice commands into data (e.g., text). Using the data associated with the voice commands, the audio gateway 110 may compare the data with a data source (e.g., an address book, a directory, etc.) to determine or identify a call recipient.

In another example, if a call recipient is using a wideband universal mobile telephone service (UMTS), then the audio gateway 110 selects a high fidelity VoIP path 216 to a high fidelity (hi-fi) bridge 218. The hi-fi bridge 218 is coupled to a high fidelity VoIP network 220 (e.g., 256 kilobit data packets) to send and receive communications via high fidelity devices associated with the media system 100. The communication path selector 204 may also select the WAS device 116 to send and/or receive data via the remote control 120.

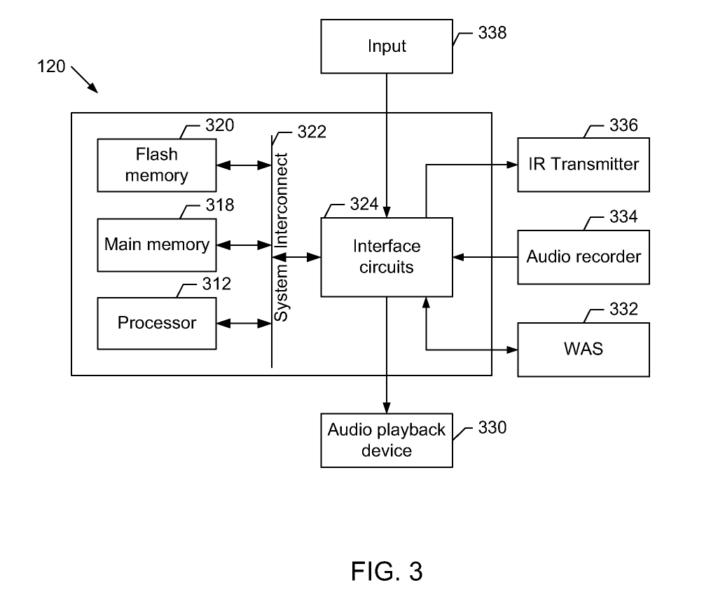

To operate the media system 100, the remote control 120 of the media system 100 is configured to send and/or receive communication services via the audio gateway 110. FIG. 3 is a block diagram illustrating the remote control 120 in more detail. The example remote control 120 includes a processor 312 such as a general purpose programmable processor. The processor 312 may be any type of processing unit, such as a microprocessor from the Intel® Centrino® family of microprocessors, the Intel® Pentium® family of microprocessors, the Intel® Itanium® family of microprocessors, and/or the Intel XScale® family of processors. Of course, other processors from other families could be used instead.

The processor 312 is in communication with a main memory including a volatile memory 318 and a non-volatile memory 320 via a bus 322. The volatile memory 318 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 320 may be implemented by flash memory and/or any other desired type of memory device. Access to the main memory 318, 320 is typically controlled by a memory controller (not shown) in a conventional manner.

The remote control 120 also includes conventional interface circuits 324. The interface circuits 324 may be implemented by any type of known interface standard, such as an Ethernet interface, a universal serial bus (USB), and/or a third generation input/output (3GIO) interface.

Additionally, the interface circuits 324 may be coupled to devices in the remote control 120 to provide additional functionality. For example, to send and/or receive high bandwidth data, the interface circuits 324 may be coupled to a WAS device 332. In the example of FIG. 3, high bandwidth data may include voice communication services such as a VoIP phone call. To enable voice communication with the remote control 120, an audio playback device 330 (e.g. a speaker, a headphone jack, a pair of headphones, etc.) may be included to playback audio signals and audio data for the person. Additionally, to record the person's voice, an audio capture device or recorder 334 (e.g., a transducer, a microphone, etc.) may be included in the remote control 120.

The remote control 120 may also send data via an IR transmitter 336 to be received by the IR receiver 114 of the audio gateway 110. The data may include commands associated with the media system 100 such as, for example, a command to increase the volume or to change the channel of an associated HDTV. To send commands to the media system 100, the remote control 120 includes an input device 330 (e.g., a series of buttons, a keyboard, a keypad, etc.). The audio gateway 110 receives and conveys the commands to a device associated with the audio gateway 110. For example, an example command may be directed to another service module (e.g., the service module 118), the communications router 104, or a communication service associated with the audio gateway 110.

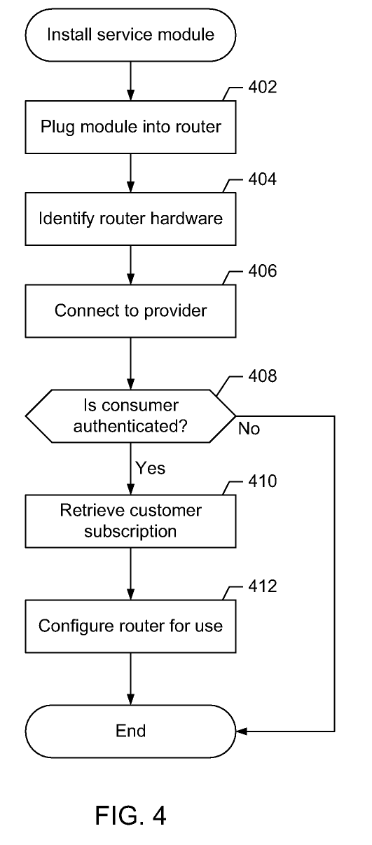

FIG. 4 is an example process 400 that is representative of an example installation of the audio gateway service module into the communications router 104. Initially, a person installs the audio gateway 110 in the communications router 104 (block 402). In one example in which the communications router 104 is presently operating, the audio gateway 110 identifies the media system hardware and configures itself to operate with the communications router 104 (block 404). Using the communications router 104, the audio gateway 110 connects to the service provider (block 406) to determine if the person is authenticated for use with the services associated with the audio gateway 110 (block 408). Additionally, the audio gateway 110 checks with the service provider to determine if the person's account is in good standing. If the person is not authenticated or the person's account is not current, an error message is displayed to the person and the example process 400 ends. If the person is authenticated, the example process 400 retrieves the subscription information from the service provider (block 410). Using the person's subscription information, the example process 400 configures the communications router 104 for use with the audio gateway 110 (block 412). Once the communications router 104 is configured to use the audio gateway 110 based on the person's subscription information, the example process 400 ends.

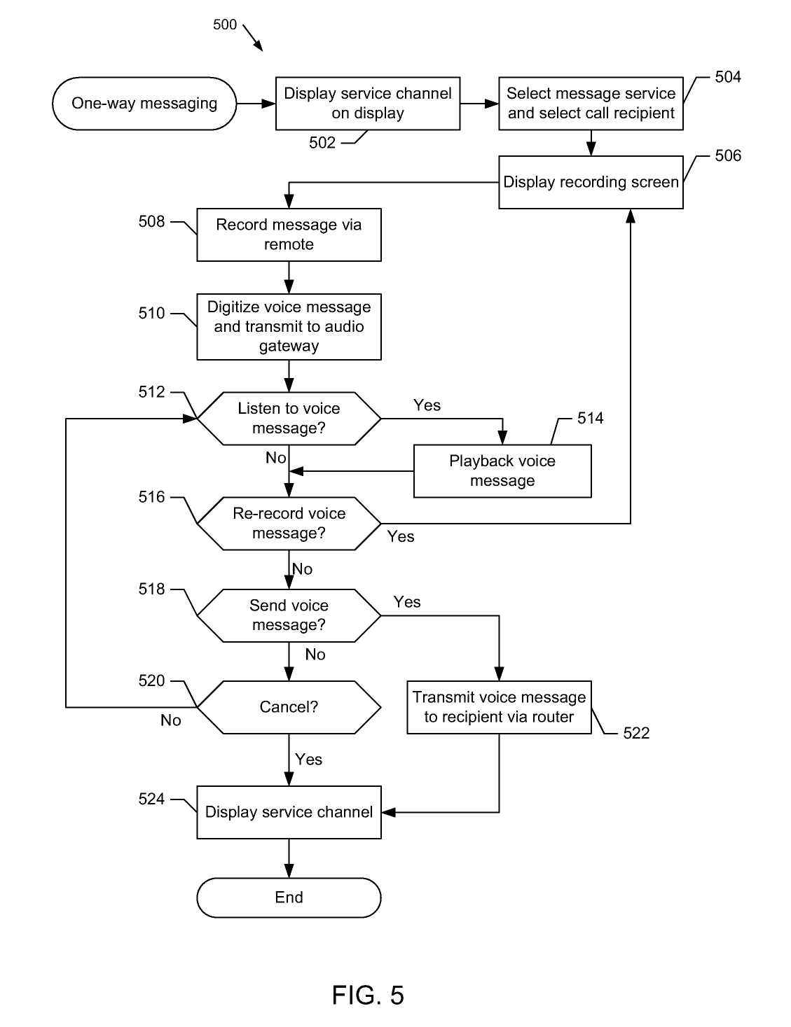

One example use of the audio gateway 110 may be to send high fidelity one-way voice messages. FIG. 5 is an example process 500 for sending half-duplex messages (i.e., one-way message) from the media system 100 via the audio gateway 110. In one example, a person may tune the display device 106 to a service channel to access functions associated with the communications router 104 (block 502). The person may select a communication service associated with the communications router 104, such as a one-way messaging service (block 504). In the example of FIG. 5, after selecting the one-way messaging service, the person selects a message recipient (block 504). Additionally, the person may send a voice command via the remote control 120 to select a recipient. For example, after selecting the one-way messaging service (block 504), a person may say “Julie's cell phone” into the remote control 120. The remote control 120 records the audio in a digital format and conveys the recorded audio to the audio gateway 110 via the WAS device 116. In the example, the audio gateway 110 receives the recorded audio and selects a path to the speech recognition device 212. The speech recognition device 212 of the audio gateway 110 converts the audio into text, compares the text with an address book associated with the person, and selects the message recipient based on the comparison.

Once a call recipient is selected, a recording screen is presented to the person (block 506) to record a message for the message recipient. Using the remote control 120, the person may record a voice message by pressing a button associated with the remote control 120 (block 508). When the person is finished recording, the person depresses another button on the remote control 120. The remote control 120 converts the voice message into digital audio format and conveys the voice message to the audio gateway 110 (block 510).

After sending the voice message to the audio gateway 110, the display device 106 may present an option for the person to listen to the voice message (block 512). If the person selects the option to listen to the voice message, the voice message is presented to the person via a device coupled to the communications router 104 (block 514). For example, the audio playback device 314 on the remote control 120 may aurally present the voice message to the person. After the voice message is presented to the person or if the person selects the option to not listen to the voice message, the person is presented with the option to re-record the voice message (block 516). If the person selects the option to re-record the voice message, the voice message is discarded and the person is presented with the recording screen (block 506). That is, the example process 500 repeats blocks 506 to 516 until the person is satisfied with the voice message.

If the person selects the option to not re-record the voice message, the person is presented a prompt to send the voice message to the message recipient (block 518). If the person selects the send message option, the audio gateway 110 identifies a communication service and selects a communication path to the message recipient (block 522) to deliver the voice message. The example process 500 clears the display and returns the display to the initial service channel (block 524) where the example process 500 ends.

If the person selects the option to not send the message, the example process 500 prompts the person to cancel sending the message (block 520). If the person cancels, the voice message is discarded, the display returns to the service channel (block 524) and the example process 500 ends. However, if the person does not cancel, the example process 500 prompts the person to listen to the voice message (block 512). That is, the example process 500 repeats blocks 512 to 520 that repeats unless the person cancels the operation at block 518, sends the message at block 520, or re-records the voice message at block 516.

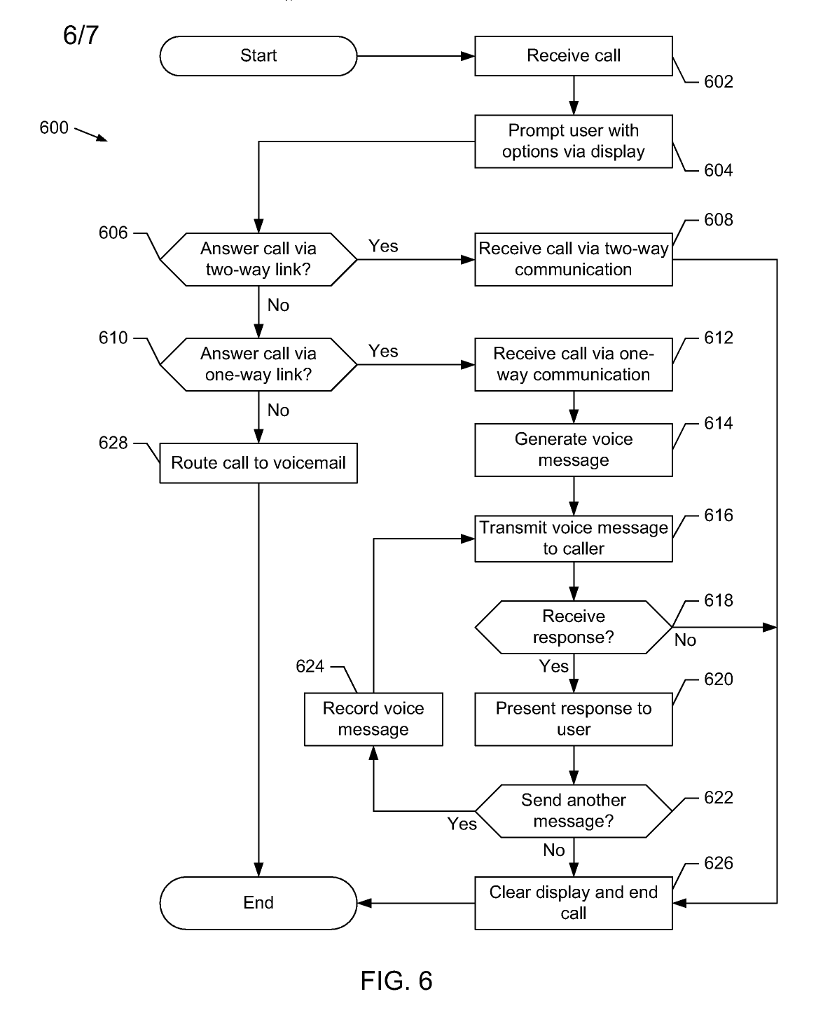

FIG. 6 is an illustration of an example process 600 to communicate via the media system 100 via a two-way (full duplex) or one-way communication link (half duplex). Before the example process 600 begins, the person may be viewing a video program via the display device 106. The example process 600 then begins when the person receives a call from a call source (block 602). When the call is received, a prompt is displayed on the display device 106 with options for the person (block 604). The prompt may be a small dialog box in one corner of the display device 106, thus allowing the person to continue to, for example, watch a video program. One option may be to answer the call via a two-way link (block 606). If the person answers the call via a two-way link, the communications router 104 routes the incoming call to the audio gateway 110, which identifies the communication service and selects a communication path to the person (block 608). For example, a high fidelity UMTS call may be coupled with the high fidelity VoIP communication device associated with the media system 100, such as the remote control 120. Alternatively, the call may be from a low fidelity source such as a VoIP source, and the audio gateway 110 may route the call to the person via the telephone 109 coupled to the VoIP network 108. The person then receives the call via the audio gateway 110 to have a two-way conversation. When complete, the display is cleared and the call ends (block 626) and, thus, the example process 600 ends.

If the person does not answer the call via a two-way link, the person may choose to answer the call via a one-way link (block 610). As described above, the communications router 104 routes the incoming call to the audio gateway 110, which identifies the communication service and selects a communication path to the person (block 612). The caller identification is retrieved via known methods and the audio gateway 110 generates a voice message based on the caller's identification (block 614). The generated message may be a combination of text-to-speech and prerecorded prompts based on the identification of the caller. The generated message is then conveyed to the caller via the audio gateway 110 (block 616). After presenting the generated message to the caller, the caller may respond to the message (block 618). If the caller does not respond to the generated message, the audio gateway 110 ends the call (block 626) and the example process 600 ends. However, if the caller does respond to the message, the audio gateway 110 presents the caller's response to the person (block 620). After presenting the message from the caller, the person may respond to the message (block 622). However, if the person elects not to send a message, the display is cleared and the call ends (block 626) and, thus, the example process 600 ends.

However, if the person does respond, the person responds by pressing a button (e.g., a button labeled “talk”) on the remote control 120 and speaking into the remote control 120 (block 624). When finished recording the message, the person presses a button (e.g., a button labeled “ok”) to send the message to the caller (block 616). In other words, the example process 600 repeats blocks 616 to 624 until the call ends. If the person does not answer the call via a one-way or two-way link, the call is routed to voicemail (block 628) where the caller may leave a message and the example process 600 ends.

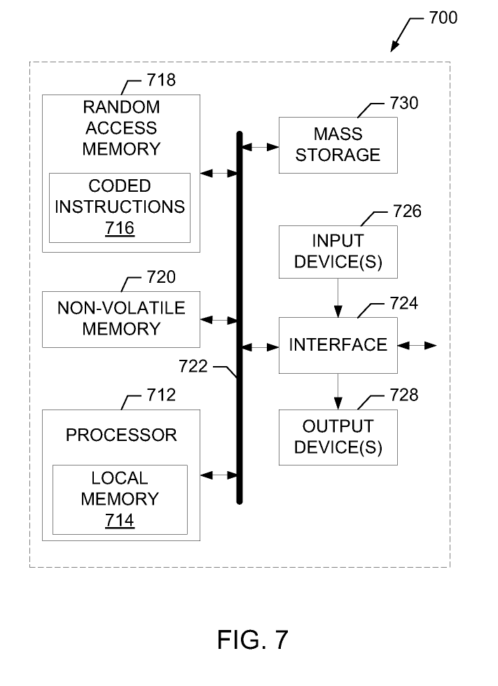

FIG. 7 is a schematic diagram of an example processor system 700 that may be used and/or programmed to implement the example communications router 104. For example, the system 700 can be implemented by one or more general purpose processors, processor cores, microcontrollers, etc.

The system 700 of the instant example includes a processor 712 such as a general purpose programmable processor. The processor 712 includes a local memory 714, and executes coded instructions 716 present in the local memory 714 and/or in another memory device. The processor 712 may execute, among other things, the example machine readable instructions illustrated in FIGS. 4, 5, and 6. The processor 712 may be any type of processing unit, such as a microprocessor from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 712 is in communication with a main memory including a volatile memory 718 and a non-volatile memory 720 via a bus 722. The volatile memory 718 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 720 may be implemented by flash memory and/or any other desired type of memory device. Access to the main memory 718, 720 is typically controlled by a memory controller (not shown) in a conventional manner.

The system 700 also includes a conventional interface circuit 724. The interface circuit 724 may be implemented by any type of well known interface standard, such as an Ethernet interface, a universal serial bus (USB), and/or a third generation input/output (3GIO) interface.

One or more input devices 726 are connected to the interface circuit 724. The input device(s) 726 permit a user to enter data and commands into the processor 712. The input device(s) can be implemented by, for example, a keyboard, a mouse, a touchscreen, a track-pad, a trackball, isopoint and/or a voice recognition system.

One or more output devices 728 may also be connected to the interface circuit 724. The output devices 728 can be implemented, for example, by display devices (e.g., a liquid crystal display, a cathode ray tube display (CRT), a printer and/or speakers). The interface circuit 724, thus, typically includes a graphics driver card.

The interface circuit 724 also includes a communication device (e.g., interface circuits 714) such as a modem or network interface card to facilitate exchange of data with external computers via a network (e.g., an Ethernet connection, a digital subscriber line (DSL), a telephone line, coaxial cable, a cellular telephone system, etc.).

The system 700 also includes one or more mass storage devices 730 for storing software and data. Examples of such mass storage devices 730 include floppy disk drives, hard drive disks, compact disk drives and digital versatile disk (DVD) drives. The mass storage device 730 may implement the local storage device 720.

Of course, persons of ordinary skill in the art will recognize that the order, size, and proportions of the memory illustrated in the example systems may vary. Additionally, although this patent discloses example systems including, among other components, software or firmware executed on hardware, it will be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, persons of ordinary skill in the art will readily appreciate that the above described examples are not the only way to implement such systems.

At least some of the above described example methods and/or apparatus are implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the methods, apparatus, and articles of manufacture described herein are not limited to such devices, standards and/or protocols. Such systems are periodically superseded by faster or more efficient systems having the same general purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1-5. (canceled)

6. A method comprising:
receiving information associated with at least one voice communication service via a multi-fidelity audio gateway; and
selecting at least one output communication path for use by the multi-fidelity audio gateway based on the at least one voice communication service.

7. The method as defined in claim 6, wherein the at least one output communication path is associated with an audio fidelity.

8. The method as defined in claim 7, wherein the audio fidelity is based on at least a sampling rate, a number of bits, or a compression algorithm.

9. The method as defined in claim 6, wherein the voice communication services comprise Internet protocol based communication services.

10. The method as defined in claim 6, wherein the at least one voice communication service comprises at least one of a voice over internet protocol, a public switched telephone network service, or a speech recognition service.

11. The method as defined in claim 6, wherein selecting the at least one output communication path for use by the multi-fidelity audio gateway device based on the at least one voice communication service comprises selecting the at least one output communication path based on a bandwidth of an internet network connection.

12. A media system comprising:
a processor to process information associated with at least one voice communication service; and
a multi-fidelity audio gateway coupled to the processor to select an output communication path to configure the media system for use with the at least one voice communication service.

13. A media system as defined in claim 12, wherein the multi-fidelity audio gateway is associated with a plurality of audio fidelities.

14. A media system as defined in claim 13, wherein each of the audio fidelities is based on at least a sampling rate, a number of bits, or a compression algorithm.

15. A media system as defined in claim 12, wherein the media system is to interact with a remote device to capture audio from a person and convey the captured audio to the media system.

16. A media system as defined in claim 15, wherein the media system is to convey the captured audio from a person to another person.

17. A media system as defined in claim 12, wherein the multi-fidelity audio gateway is provided via a service module.

18. A media system as defined in claim 17, wherein the service module is to be received by the media system while the media system is operating.

19. A media system as defined in claim 17, wherein the media system is to be associated with at least one additional service module to provide at least one service to the media system.

20. A media system as defined in claim 19, wherein the multi-fidelity audio gateway is to interact with the at least one additional service module.

21. An apparatus to control a media system, comprising:
an audio interface to receive first audio information from the media system via a communication link and present the first audio information to a person; and
an audio instrument to receive audio from the person and convey second audio information to the media system via the communication link.

22. An apparatus as defined in claim 21, further comprising a processor to convert the first audio information into digital information.

23. An apparatus as defined in claim 21, further comprising a communication device is to convey audio information via the communication link.

24. An apparatus as defined in claim 23, wherein the media system is to convey the second audio information to another person via a voice communication service associated with the media system.

25. An apparatus as defined in claim 21, wherein the media system is to receive the first audio information via a voice communication service associated with the media system.

26. An apparatus as defined in claim 25, wherein the media system is to convey the first audio information via a communication device.

27-29. (canceled)

30. An apparatus comprising:
means for processing information associated with at least one voice communication service; and
means for selecting at least one output communication path to configure a media system for use with the at least one voice communication service.

31. An apparatus as defined in claim 29, wherein the at least one output communication path is associated with an audio fidelity.

32. An apparatus as defined in claim 30, wherein the audio fidelity is based on at least a sampling rate, a number of bits, or a compression algorithm.

33. An apparatus as defined in claim 29, wherein the at least one voice communication service comprises at least one of a voice over internet protocol, a public switched telephone network service, or a speech recognition service.

34. An apparatus as defined in claim 29, wherein the means for selecting the output communication path comprises means for selecting the at least one communication path based on a bandwidth of an internet network connection.
